(19) United States
(12) Patent Application Publication
(10) Pub. No.: US 2009/0114327 A1
(43) Pub. Date: May 7, 2009

(54) COMPOSITION BASED ON SILOXANE FOR THE MOULDING/UNMOULDING OF TYRES

(76) Inventor: Stefan Breunig, Villette De Vienne (FR)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/910,960

(22) PCT Filed: Apr. 6, 2006
(86) PCT No.: PCT/FR06/00764

§ 371 Date: May 20, 2008

(30) Foreign Application Priority Data
Apr. 8, 2005 (FR) 0503502

(51) Int. Cl. B60C 5/00; C08L 83/04; C08K 3/26; C08K 3/00; C08K 3/34

(52) U.S. Cl. 152/450; 524/588; 524/425; 524/449

(57) ABSTRACT

The invention relates to compositions in the form of silicon oil emulsion to be applied to curing bladders as an adhesion primer during the production of tyres. The invention also relates to curing bladders coated by an inventive adhesion primer.

The present invention relates to compositions, in the form of a silicone emulsion which can be cured to give an elastomer by evaporation of the water and crosslinking, which are intended to be applied to curing bladders as bonding primer during the manufacture of tires.

The invention also relates to the curing bladders coated with a bonding primer according to the invention.

Rubber tires for vehicles are usually manufactured by molding and vulcanizing an assembly based on a cover made of raw rubber, or which is not vulcanized and not shaped, in a molding press in which the raw cover is pressed outwards against the surface of a mold by means of a bladder made of butyl rubber which can be dilated by an internal fluid (steam, nitrogen, and the like). By this process, the raw cover is shaped against the external surface of the mold, which defines the pattern of the tread of the cover and the configuration of the side walls. The cover is vulcanized by heating. Generally, the bladder is dilated by the internal pressure provided by a fluid, such as a compressed gas (hot), hot water and/or steam, which also participates in the transfer of heat for the vulcanization. The cover is then allowed to cool slightly in the mold, this cooling sometimes being promoted by the introduction of cold or cooler water into the bladder. The mold is then opened, the bladder is deflated by releasing the pressure of the internal fluid and the cover is removed from the cover mold. This use of curing bladders is well known in the art.

It is acknowledged that a significant relative movement takes place between the external contact surface of the bladder and the internal surface of the cover during the phase of dilation of the bladder before the complete vulcanization of the cover. Likewise, a considerable relative movement also takes place between the external contact surface of the bladder and the vulcanized internal surface of the cover, after the cover has been molded and vulcanized, during the deflation and removal of the bladder from the tire.

If appropriate lubrication is not provided between the bladder and the internal surface of the cover, the bladder generally has a tendency to warp, which results in deformation of the cover in the mold and also in excessive wear and excessive tarnishing of the surface of the bladder itself. The surface of the bladder also tends to stick to the internal surface of the cover after the vulcanization of the cover and during the part of the cover vulcanization cycle during which the bladder is deflated. In addition, air bubbles can be trapped between the surfaces of the bladder and of the cover and can promote the appearance of defects in the vulcanization of the covers resulting from inadequate heat transfer.

As the molding/mold release operations proceed, the bladder becomes damaged and the adhesion-resistant performance of the lubricant declines, thus greatly limiting the molding/mold release number, which is a critical factor for the tire industry.

It is for this reason that, before the use of a lubricating composition, it is advantageous to apply a bonding primer to the external surface of the bladder in order to protect the bladder and to optimize the molding/mold release number.

Furthermore, before the first molding/mold release cycle, the bladder coated with the primer is in the majority of cases inflated by injection of a hot gas in order to optimize its elasticity performance; the primer is then subjected to an elongation of the order of 300%.

During use, the molding/mold release cycle is repeated several times according to the lifetime of the bladder, which results in significant physical stresses on the primer. The resistance to elongation is thus one of the important criteria for a bonding primer, which thus has to be capable of withstanding an elongation of 300% on a dilatable bladder without physical deterioration while providing good affinity with the lubricating compositions used in order to optimize the molding/mold release number per bladder. The primer must also exhibit good properties of adhesion to the bladder in order to avoid any phenomenon of detachment. The term “good affinity” is understood to mean that the lubricant must adhere to the primer in order to ensure the action thereof over several molding/mold release cycles.

Application WO 03/087227 describes a composition in the form of an emulsion of silicone oil in water, based on siloxane which does not give off hydrogen, of use in the molding/mold release of tires, comprising:
(a) optionally at least one unreactive linear polyorganosiloxane oil with lubricating properties, exhibiting a dynamic viscosity of the order of 5×10⁻² to 30×10² Pa·s at 25° C.;
(a′) at least one reactive linear polyorganosiloxane oil comprising at least two OH groups per molecule and exhibiting a dynamic viscosity ranging from 5×10⁻² to 200 000 Pa·s, in particular from 5×10⁻² to 150 000 Pa·s, preferably from 5×10⁻² to 3000 Pa·s, at 25° C.;
(b) at least one polyorganosiloxane resin carrying condensable hydroxyl substituents and comprising at least two siloxyl units;
(c) at least one crosslinking agent which is soluble in the silicone phase and which comprises at least two functional groups capable of reacting with the polyorganosiloxane resin (b);
(d) at least one condensation catalyst capable of catalyzing the reaction of the constituent (b) with the constituent (c);
(e) at least one surfactant; and
(f) water,
   the constituent (a)/constituent (a′) ratio by weight lying within the range from 0 to 10.

This composition, when it is crosslinked on the bladder, can act either as a lubricating composition or as a bonding primer having sufficient lubricating properties to thus avoid the application of an additional lubricating composition.

However, although advantageous with regard to the lubricating aspect, this type of composition exhibits bonding primer properties which are still inadequate, in particular when the bladder is inflated before the first use thereof in order to optimize the performance thereof. The primer must then be able to withstand an elongation equivalent to 300% at temperatures ranging from ambient temperature up to temperatures which can be greater than 150° C.

It is also of use to develop primers having good bonding properties on the bladder and good affinity with the lubricating compositions used.

The tire industry is thus still looking for a bonding primer capable:
of providing for the formation of a continuous film with good adhesion to the bladder, thus resulting in the protection of the surface of the bladder, thus making possible an increase in the molding/mold release number for each bladder used (increased lifetime), and
of withstanding an elongation of 300% at temperatures ranging from ambient temperature up to temperatures which can be greater than 150° C. (in particular during the cycle for rendering the bladder flexible before it is used for the first time), and
of providing good affinity with a lubricant during a molding/mold release cycle, thus resulting in an increase in the molding/mold release number for each application of mold release/lubricating product.

It is thus an object of the present invention to provide a novel use of an aqueous silicone emulsion which can be cured to give an elastomer by evaporation of the water and crosslinking to form a bonding primer on a dilatable curing bladder for the manufacture of a tire, said bonding primer making it possible:
to withstand an elongation of 300% at ambient temperature (approximately 20° C.) and/or at a temperature≧150° C.,
to have good adhesion to the bladder, and
to provide good affinity with a lubricant during a molding/mold release cycle,
   said emulsion being composed:
   (i) of a silicone phase composed:
of at least one crosslinkable linear polyorganosiloxane oil A comprising hydroxyl and/or alkoxyl functional groups with a dynamic viscosity of between 20 000 and 2×10⁶ mPa·s, preferably of between 70×10³ and 1.1×10⁶ mPa·s and more preferably still of between 100×10³ and 300×10³ mPa·s,
of at least one crosslinking agent D comprising hydroxyl and/or alkoxyl functional groups, such as, for example, a hydroxylated and/or alkoxylated polyorganosiloxane resin or a silicon-comprising adhesion promoter having hydroxyl and/or alkoxyl crosslinking functional groups,
when the crosslinking agent D is not a silicon-comprising adhesion promoter having hydroxyl and/or alkoxyl crosslinking functional groups, at least one silicon-comprising adhesion promoter B is optionally present,
   with the condition according to which at least one of the constituents A, B and D carries at least three crosslinking functional groups per molecule, and
   (ii) of a non-silicone hydrophilic phase composed:
of at least one filler FI dispersible in an aqueous phase in a proportion of at least 5% by weight, preferably between 10% and 50% by weight, with respect to the total weight of the emulsion;
of at least one surfactant SU, and
optionally of at least one polycondensation catalyst C and/or at least one adhesion promoter B′ which is soluble in water, and
   (iii) of water,
   said emulsion optionally comprising, as additional additives, at least one plasticizer G and/or at least one bactericide H.

The constituents of the emulsion are defined with reference to their initial chemical structure, that is to say that which characterizes them before emulsification. As soon as they are in an aqueous medium, their structure is capable of being greatly modified as the result of hydrolysis and condensation reactions.

The term “dynamic viscosity” is understood to mean, in the context of the invention, the viscosity of newtonian type, that is to say the dynamic viscosity, measured in a way known per se at a given temperature, at a shear rate gradient sufficiently low for the viscosity measured to be independent of the rate gradient.

The main constituent of the emulsion, with regard to weight, is the polyorganosiloxane A, which preferably comprises at least one viscous and reactive silicone homopolymer or copolymer capable of forming, by polycondensation, a crosslinked three-dimensional network in combination with a crosslinking agent D. The functional groups under consideration are functional groups which give access to crosslinking, preferably by (hydrolysis)/condensation. These functional groups are hydroxyls or alkoxyls.

According to an advantageous alternative form, the crosslinkable polyorganosiloxane A is a polydiorganosiloxane oil exhibiting, per molecule, at least two condensable or hydrolysable groups SiOR^{a}, with: R^{a}═H or alkyl, preferably R^{a}═H; said polyorganosiloxane A being crosslinkable by condensation or hydrolysis/condensation, optionally in the presence of a condensation catalyst C; and the crosslinking agent D comprising at least one hydroxylated and/or alkoxylated silicone resin and optionally at least one alkoxysilane E. Mention may be made, as examples of alkoxysilane E, of: ViSi(OEt)₃, ViSi(OMe)₃, Si(OEt)₄, MeSi(OMe)₃ and Si(OMe)₄.

As preferred constituent, the crosslinkable polyorganosiloxane A has the following formula (I):

[(R^{f}O)ₐR^{e}₍₃₋ₐ₎SiO_{1/2}][R³R⁴SiO_{2/2}]ₘ[R⁵R⁶SiO_{2/2}]ₙ[R⁷R⁸SiO_{2/2}]ₒ[R³R^{N}SiO_{2/2}]ₚ[(R^{f}O)ₐR^{e}₍₃₋ₐ₎SiO_{1/2}]
in which formula:
   R^{f}=corresponds to hydrogen or to a linear or branched C₁-C₄ alkyl, optionally substituted by a linear or branched C₁-C₃ alkyl, preferably a methyl, ethyl, propyl or ethoxyethyl;
   R³, R⁴, R⁵, R⁶, R⁷ and R⁸ are identical or different radicals chosen from the group consisting of: linear or branched C₁-C₃₀ alkyls, preferably a methyl, linear or branched C₂-C₂₀ alkenyls, C₆-C₁₂ aryls, optionally substituted by 1 to 3 linear or branched C₁-C₃ alkyls, aralkyls comprising, for the aryl part, C₆-C₈ carbon atoms and, for the linear or branched alkyl part, C₁-C₄ carbon atoms, such as a benzyl, a phenethyl

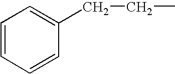

or the following radical

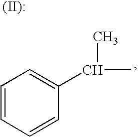

and aralkenyls comprising, for the aryl part, C₆-C₈ carbon atoms and, for the linear or branched alkenyl part, C₂-C₄ carbon atoms,
R^{N} corresponds to radicals, identical to or different from one another, which are defined as being aminated radicals, preferably aminoalkyls, or alkyl radicals comprising one or more epoxide and/or carboxyl and/or methacryloyloxy and/or mercapto and/or isocyanate and/or isocyanurate and/or cyano functional groups;
R^{e} represents radicals, identical to or different from one another, which are defined as being radicals corresponding to the same definition as that given above for R³ to R⁸ and/or radicals corresponding to the same definition as that given above for R^{N};
a=1, 2 or 3, and
m, n, o and p≧0 with m+n+o+p≧500 and, preferably, m+n+o+p≧650.

According to an advantageous form, the crosslinkable polyorganosiloxane A is a silicone oil formed by a homo- or copolymer of formula (I) given above in which:
R^{f} corresponds to hydrogen,
a=1, p=0 and
R^{e} and R³ to R⁸ are radicals, identical to or different from one another, chosen from the group consisting of:
linear or branched C₁-C₁₅ alkyls, preferably methyl, ethyl or propyl, phenyls, tolyls, benzyl radicals, phenethyls, styryls and radicals of formula:

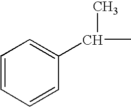

Mention may be made, among the constituents preferred for the crosslinkable polyorganosiloxane oil A, of the linear polyorganosiloxanes of formula:

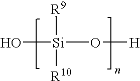

in which formula n is an integer greater than or equal to 500 and R⁹ and R¹⁰, which are identical or different, represent: a C₁-C₆ alkyl; a C₃-C₈ cycloalkyl; a C₂-C₈ alkenyl; a C₅-C₈ cycloalkenyl; an aryl; an alkylarylene and an arylalkylene; each of the abovementioned radicals optionally being substituted by a halogen atom (and preferably fluorine) or a cyano residue.

The most widely used oils, due to their availability in industrial products, are those for which R⁹ and R¹⁰ are chosen independently from the group of the radicals consisting of: a methyl, an ethyl, a propyl, an isopropyl, a cyclohexyl, a vinyl, a phenyl and a 3,3,3-trifluoropropyl. Very preferably, at least approximately 80% by number of these radicals are methyl radicals.

In practice, preference will be given, as crosslinkable polyorganosiloxane oil A, to α,Ω-dihydroxypoly(dimethyl)(methylphenyl)siloxane oils and in particular to the oils of this type prepared by the anionic polymerization process described in the abovementioned U.S. Pat. No. 2,891,920 and in particular U.S. Pat. No. 3,294,725 (which are cited as reference). This emulsion polymerization process is particularly advantageous as it makes it possible to directly obtain an emulsion comprising the polysiloxane A. Moreover, this process makes it possible to obtain, without difficulty, polyorganosiloxane oils A in an emulsion of high viscosity.

In accordance with the invention, it will be preferable, however, to start from prepolymerized polyorganosiloxane oils A for the preparation of the emulsion, for example using the techniques for the emulsification of the silicone phase described in FR-A-2 697 021.

Furthermore, it is necessary for the dynamic viscosity ρ at 25° C. of these polyorganosiloxanes A to be between 20 000 and 2×10⁶ mPa·s, preferably between 70×10³ and 1.1×10⁶ mPa·s and more preferably still between 100×10³ and 300×10³ mPa·s.

The dynamic viscosity η of the polyorganosiloxane A is one of the essential characteristics in producing a bonding primer exhibiting a combination of suitable mechanical properties, in particular for the elongation at break and the adhesion to the bladder.

As regards the mechanical properties concerning the elongation at break, the filler FI plays an important role. The fillers FI employed can, for example, be reinforcing siliceous fillers FI. Such siliceous fillers have a particle size generally of between a few nanometers and 300 μm and a BET specific surface of greater than 50 m²/g. These siliceous fillers are chosen, e.g., from colloidal silicas, fumed silica powders, precipitated silica powders or their mixtures. These silicas are well known; they are used in particular as fillers in silicone elastomer compositions which can be heat-cured to give a silicone rubber. These silicas exhibit a mean particle size generally of less than 0.1 μm and a BET specific surface preferably of between 100 and 350 m²/g.

It is also possible, optionally, to use semi-reinforcing siliceous fillers, such as diatomaceous earths, ground quartz, micas or optionally an alumina hydrate or a titanium dioxide.

Preferably, the filler FI dispersible in the aqueous phase is chosen from the group consisting of colloidal silicas, fumed silica powders, precipitated silica powders, calcium carbonate and their mixtures.

These fillers FI are introduced into the emulsion in the form of a dry powder or in the form of colloidal emulsions, for example by simple mixing.

Mention may be made, as crosslinking agent D, of a hydroxylated and/or alkoxylated silicone resin having a content by weight of hydroxyl and/or alkoxyl groups of between 0.1 and 10%, preferably between 0.2 and 5%. This resin D exhibits, per molecule, at least two different units chosen from those of formula M, D, T and Q, at least one being a T or Q unit, with

### M=(R¹¹)₃SiO_{1/2}

### D=(R¹¹)₂SiO_{2/2}

### T=R¹¹SiO_{3/2} and

### Q=SiO_{4/2},

in which formulae the R¹¹ radicals, which are identical or different, represent a monovalent organic substituent. Mention may be made, as examples of monovalent organic substituents of these units, of the methyl, ethyl, isopropyl, tert-butyl, n-hexyl and phenyl radicals.

These silicone resins are well known branched organopolysiloxane polymers, the processes for the preparation of which are described in a great many patents. Mention may be made, as examples of resins which can be used, of MQ resins, MDQ resins, TD resins and MDT resins. Use may be made of the resins which are solid or liquid at ambient temperature. These resins can be incorporated as is in emulsions in the polyorganosiloxane A, in solution in an organic solvent or a silicone oil, or else in the form of aqueous emulsions (EP-A-0 359 676).

Aqueous emulsions of silicone resins which can be used are, for example, described in U.S. Pat. No. 4,028,339, U.S. Pat. No. 4,052,331, U.S. Pat. No. 4,056,492, U.S. Pat. No. 4,525,502 and U.S. Pat. No. 4,717,599, which are cited as reference.

As indicated above, this resin D can act as crosslinking agent by virtue of its hydroxyl and/or alkoxyl functional groups, which are capable of reacting by condensation with the crosslinkable groups of the silicone oil A.

According to a preferred form, the crosslinking agent D is a polyorganosiloxane resin carrying condensable hydroxyl substituents and comprising at least two different siloxyl units chosen from those of formula (R¹¹)₃SiO_{1/2} (M), (R¹¹)₂SiO_{2/2} (D), R¹¹SiO_{3/2} (T) and SiO_{4/2} (Q), at least one of these units being a T or Q unit, in which formulae R¹¹ represents a monovalent organic substituent as defined above, said resin exhibiting a content by weight of hydroxyl substituents of between 0.1 and 10% by weight and preferably between 0.2 and 5% by weight.

Mention may be made, as concrete examples of resins which can be used, of hydroxylated MQ, MDQ, DQ, DT and MDT resins and mixtures of these. In these resins, each OH group is carried by a silicon atom belonging to an M, D or T unit.

Preferably, mention may be made, as examples of resins which can be used, of hydroxylated organopolysiloxane resins not comprising a Q unit in their structure. More preferably, mention may be made of hydroxylated DT and MDT resins comprising at least 20% by weight of T units and having a content by weight of hydroxyl groups ranging from 0.1 to 10% and better still from 0.2 to 5%. In this group of most preferred resins, those where the mean number of R¹¹ substituents for a silicon atom is between 1.2 and 1.8 per molecule are more particularly suitable. More advantageously still, use is made of resins of this type, in the structure of which at least 80% by number of the R¹¹ substituents are methyl radicals.

The resin is liquid at ambient temperature. Preferably, the resin exhibits a dynamic viscosity at 25° C. of between 0.2 and 200 Pa·s, in particular between 0.5 and 50 Pa·s, better still between 0.8 and 5 Pa·s.

According to a preferred embodiment, said emulsion is diluted for applications by compressed air spraying so that the amount of water is between 0.5% and 55% by weight, preferably between 1.5% and 45% by weight and more preferably still between 30% and 45% by weight, with respect to the total weight of the emulsion.

Examples of polycondensation catalysts C which can be used in the context of the invention are organometallic salts and titanates, such as tetrabutyl orthotitanate. Mention may be made, as organometallic salt, of zirconium naphthenate and zirconium octylate.

Said catalyst is preferably a catalytic tin compound, generally an organotin salt. The organotin salts which can be used are described in particular in the work by Noll, Chemistry and Technology of Silicones, Academic Press (1968), page 397. It is also possible to define, as catalytic tin compound, either distannoxanes or polyorganostannoxanes or the reaction product of a tin salt, in particular of a tin dicarboxylate, with polyethyl silicate, as described in U.S. Pat. No. 3,862,919.

The reaction product of an alkyl silicate or of an alkyltrialkoxysilane with dibutyltin diacetate, as described in Belgian patent BE-A-842 305, may also be suitable.

According to another possibility, recourse is had to a tin(II) salt, such as SnCl₂ or stannous octoate.

Advantageously, the catalyst is the tin salt of an organic acid, such as dibutyltin diacetate, dibutyltin dilaurate, dioctyltin dilaurate, dibutyltin dioctoate, zinc naphthenate, cobalt naphthenate, zinc octylate, cobalt octylate and dioctyltin di(isomercaptoacetate).

The preferred tin salts are tin bischelates (EP-A-147 323 and EP-A-235 049), diorganotin dicarboxylates and in particular the catalysts described in British patent GB-A-1 289 900, such as dibutyltin or dioctyltin diacetate, dibutyltin or dioctyltin dilaurate or the hydrolysis products in the abovementioned entities (for example, diorgano- and polystannoxanes).

The polycondensation catalyst C is generally introduced into the emulsion in a proportion of 0.05 to 5 parts by weight, with respect to the total weight of the emulsion. Dioctyltin dilaurate or di(2-ethylhexyl)tin dilaurate is very particularly preferred.

The nature of the surfactant SU will be easily determined by a person skilled in the art, the object being to prepare a stable emulsion. Anionic, cationic, nonionic and zwitterionic surfactants can be employed, alone or as a mixture.

Mention may be made, as anionic surfactant, of alkali metal salts of hydrocarbon-comprising aromatic sulfonic acids or alkali metal salts of alkyl sulfates. Nonionic surfactants are more particularly preferred in the context of the invention. Mention may be made, among these, of alkyl or aryl ethers of poly(alkylene oxide), polyoxyethylenated sorbitan hexastearate, polyoxyethylenated sorbitan oleate having a saponification number of 102 to 108 and a hydroxyl number of 25 to 35, and poly(ethylene oxide) cetearyl ethers.

Mention may be made, as poly(alkylene oxide) aryl ether, of polyoxyethylenated alkylphenols. Mention may be made, as poly(alkylene oxide) alkyl ether, of polyethylene glycol isodecyl ether and polyethylene glycol trimethylnonyl ether comprising from 3 to 15 ethylene oxide units per molecule.

Mention may also be made of ethoxylated isotridecyl alcohol, e.g. with from 8 to 9 mol of ethylene oxide per mole of isotridecyl alcohol.

The amount of surfactant SU depends on the type of each of the opposing constituents and on the actual nature of the surfactant used. Generally, the emulsion comprises from 0.5 to 10% by weight of surfactant (better still from 0.5 to 5% by weight). According to another preferred embodiment, the surfactant SU is present at up to 3% by weight, with respect to the total weight of the emulsion.

According to another preferred embodiment, the emulsion according to the invention has the following composition, in parts by weight:
100 parts of at least one α,Ω-dihydroxylated polydiorganosiloxane silicone oil A,
from 0 to 10 parts:
   of at least one adhesion promoter B and/or B′ chosen from the group consisting of: the hydrolysis product of an aminoalkyltrialkoxysilane, bisaminoalkyltrialkoxysilane and/or trisaminoalkyltrialkoxysilane, aminated silicone oligomers or resins comprising D, T and/or Q siloxyl units, optionally M siloxyl units, with at least a portion of the D, T and M units carrying one or more amine functional groups,
from 1 to 20 parts of at least one crosslinking agent D chosen:
   from hydroxylated silicone resins, preferably from resins of the type T^{(OH)}, DT^{(OH)}, DQ^{(OH)}, DT^{(OH)}, MQ^{(OH)}, MDT^{(OH)}, MDT^{(OH)} and their mixtures, these resins having silicons substituted by vinyl and/or phenyl and/or 3,3,3-trifluoropropyl and/or linear or branched C₁-C₆ (advantageously C₁) alkyl radicals, and/or
from 0 to 5 parts of at least one alkoxysilane E of formula:

R^{b}₍₃₋ₜ₎Si(OR^{a})ₜ
with R^{a}═H or alkyl, preferably R^{a}═H, R^{b}=optionally substituted C₁-C₆ (cyclo)alkyl or alkenyl, and t=1, 2 or 3;
from 0 to 2 parts of at least one condensation catalyst C;
from 0.5 to 10 parts of at least one surfactant SU,
from 2 to 40 parts of at least one siliceous filler FI preferably selected from the group consisting of: a precipitated or non-precipitated silica, a colloidal silica, a silica in powder form, micas and mixtures of these products,
from 0.5 to 50 parts of water, and
from 0 to 20 parts of at least one siliceous additive SA, such as organosilicate or sodium silicate.

The adhesion promoters B or B′ are known to a person skilled in the art, which, depending on their natures, will be preferentially soluble in the aqueous phase or in the silicone phase. Advantageously, they will be silanes carrying, per molecule, in addition to at least one OH group, at least one organic group comprising a functional group Fr, Fr representing an optionally substituted amino, epoxy, optionally substituted acryloyl (CH₂═CH—CO—), optionally substituted methacryloyl (CH₂═C(CH₃)—CO—), optionally substituted ureido (NH₂—CO—NH—), optionally substituted thiol or halogen functional group.

The optional organic substituents of the adhesion promoters B or B′ other than the OH group(s) and the organic group(s) comprising a functional group Fr are: linear or branched alkyl radicals having from 1 to 6 carbon atoms; cycloalkyl radicals having from 3 to 8 carbon atoms; linear or branched alkenyl radicals having from 2 to 8 carbon atoms; aryl radicals having from 6 to 10 carbon atoms; alkylarylene radicals having from 6 to 15 carbon atoms; or arylalkylene radicals having from 6 to 15 carbon atoms. The solubility in the silicone phase and/or the hydrophilic phase being a function

According to a preferred embodiment of the invention, Fr is an optionally substituted amino functional group.

According to a more preferred embodiment of the invention, the water-soluble adhesion promoter B′ has the formula:

R¹²R¹³N—R⁹—Si(OH)₃

in which R^{g} represents a C₁-C₁₀ alkylene radical and R¹² and R¹³ independently represent a hydrogen atom or a (C₁-C₆) alkyl group.

Mention may be made, as an example, of 3-aminopropyltrihydroxysilane.

This constituent, when it is present in the emulsion, is used in a proportion of 0.5 to 15 parts by weight, with respect to the total weight of the emulsion, preferably in a proportion of 0.6 to 5 parts by weight and better still in a proportion of 0.8 to 3 parts by weight.

Mention may be made, as example of plasticizers G, although this is not limiting, of alkylbenzenes and in particular of those described in patent application FR 2 446 849.

According to an advantageous alternative form, the emulsion of the invention as defined above is additionally characterized in that it comprises droplets of dispersed silicone phase existing in an at least partially crosslinked form.

The emulsion can be stored in this form, before use, in an appropriate packaging, with the exclusion of air. It is only after application to the bladder that the droplets of dispersed silicone phase fuse by coalescence to form a homogeneous material which subsequently completes its conversion to elastomer by crosslinking and removal of water (evaporation).

The preparation of the aqueous silicone emulsion can be carried out starting from an emulsion of at least a portion of the silicone phase (i) in an aqueous phase comprising at least a portion of the hydrophilic phase (ii) and/or water, using mechanical stirring means.

Thus, the silicone phase (i), which is emulsified in the aqueous phase, comprises all or a portion of its constituents [A, B, D, inter alia] before the stage of emulsifying proper (mixing/homogenization-stirring) with the aqueous phase (non-silicone hydrophilic phase (ii)) occurs.

The filler FI of the non-silicone hydrophilic phase is preferably added to the mixture after the emulsification. The emulsification is advantageously carried out using conventional homogenizing and stirring means, such as, for example, kneaders, planetary mixers, colloid mills, extruders of the single- or twin-screw type or homogenizers, at a temperature for example of between 10 and 50° C. The pH is optionally adjusted to between 4 and 13 by addition of organic or inorganic acid or base (e.g., potassium hydroxide or amine).

The final emulsion obtained is homogenized and then optionally degassed and is subsequently packaged in a packaging with air and water vapor excluded.

The emulsion can be stored in this form, before use, in an appropriate packaging, with the exclusion of air.

This emulsion is intended to be applied to a dilatable bladder before use of a lubricating composition. The application of this emulsion can be carried out by conventional methods, such as spraying, brushing, application using a sponge or application using a brush. It is only after application to the bladder that the droplets of the silicone phase (i) fuse by coalescence to form a homogeneous material which subsequently completes its conversion to elastomer by crosslinking and removal of water (evaporation). The emulsion forms an adherent elastomer on the bladder by crosslinking (e.g., polycondensation) accompanied by removal of water (preferably at ambient temperature).

This bonding primer has proven to be particularly useful in combination with lubricating compositions (or mold-release agents) devoid of (SiH) groups and more particularly with the lubricating compositions described in applications FR-A-2 802 546, FR-A-2 825 099, FR-A-2 838 447 and WO-03/087227.

The mold-release agent is either applied to the bladder coated with the primer or to the internal surface of the uncured tire (inner liner). This combination allows the uncured tire to slide over the bladder when the press is closed while ensuring that the stage of removing the cured (vulcanized) tire from the mold proceeds satisfactorily. The primer according to the invention/mold-release agent system makes it possible to prevent adhesion of the vulcanized tire to the bladder. Thus, the number of releases from the mold possible per application of mold-release agent but also the number of releases from the mold possible per bladder is increased without loss in quality with regard to the vulcanized tire, in particular with regard to the symmetry of the tires thus obtained.

Another subject matter of the present invention is thus the process which consists of applying the oil-in-water emulsion which has just been described to the surface of a dilatable bladder as bonding primer. After application, crosslinking is carried out by drying at ambient temperature, which crosslinking can be accelerated by heating, in particular at 80-180° C., preferably at 120-170° C.

Another subject matter of the invention is a dilatable rubber bladder coated on its external surface with an aqueous silicone emulsion which can be cured to give an elastomer by evaporation of the water and crosslinking as described above, for the shaping and vulcanization of pneumatic or semi-pneumatic tires. The lifetime of this bladder thus obtained is found to be extended.

Another subject matter of the invention is a dilatable rubber bladder coated with a bonding primer according to the invention capable of being obtained by drying and/or heating a bladder at a temperature of 20 to 180° C.

The final subject matter of the invention is the use of a dilatable rubber bladder coated with a bonding primer according to the invention in combination with a non-vulcanized tire, the internal surface of which has been treated with a lubricating composition, for the manufacture of tires.

The following examples, which illustrate the invention, testify to the excellent properties of the bonding primers starting from the emulsions according to the invention.

### EXAMPLE 1

This example illustrates an emulsion according to the invention. The formulation of this composition, which is an oil-in-water emulsion, is given in the following table 1:

TABLE 1
Emulsion A (invention)

| | | Parts |
|---|---|---|
| | | by |
| Nature of the constituent | Identification | weight |
| α,ω-Dihydroxylated | Constituent A | 54.5 |
| poly(dimethyl)(methylphenyl)- | | |
| siloxane silicons oil, viscosity = | | |
| 135 000 mPa · s | | |
| Silicone resin comprising MDT | Constituent D | 5.1 |
| units and comprising 0.5% by | | |
| weight of OH groups (dynamic | | |
| viscosity at 25° C. = 1 Pa · s) | | |
| Filler, Ludox TM 50 (aqueous sol | Constituent FI | 17 |
| comprising 50% of colloidal | | |
| silica from DuPont) | | |
| Dioctyltin dilaurate emulsion ⁽¹⁾ | Constituent C | 0.35 |
| Polyethoxylated isotridecyl | Constituent SU | 1.3 |
| alcohol ⁽²⁾ | | |
| 23% solution of | Constituent B′ | 4.8 |
| NH₂—(CH₂)₃—Si(OH)₃ | | |
| Bactericide | Constituent H | 0.05 |
| Plasticizer Progilin 155 | Constituent G | 13.6 |
| (alkylbenzene from Chevron) | | |
| Distilled water | Constituent (iii) | 3.3 |
| | | 100 |

⁽¹⁾ 37.5% by weight dioctyltin dilaurate emulsion in water, prepared using polyvinyl alcohol as surfactant.
⁽²⁾ mixture of 15% of water and of 85% of isotridecyl alcohol ethoxylated with 8 to 9 mol of ethylene oxide per mole of isotridecyl alcohol.

The promoter B′ is an aqueous solution of aminated T(OH) resin prepared by preparing a 40% aqueous γ-aminopropyltriethoxysilane solution and by then stripping off the ethanol formed by hydrolysis. The solution is completely clear and exhibits a solids content of 23%.

### Preparation of the Emulsion According to the Invention

The breakdown of the composition is described in table 1.
A mixture of the constituent A, of the hydroxylated silicone resin D and of the plasticizer G is prepared in a beaker (and using an anchor stirrer);
the water, the surfactant SU and the filler FI are introduced into a 1.5 liter IKA reactor and then stirring is carried out at 100 revolutions/min for 10 minutes;
the above silicone phase (i) is gradually introduced using a dropping funnel and with stirring (150 revolutions/min) into the IKA reactor comprising the surfactant SU, the silica FI and the water;
subsequently, the adhesion promoter B′ and the catalyst C are added and stirring is maintained for a further 10 min. The biocide is subsequently added to the emulsion, followed by stirring for 10 minutes. An oil-in-water emulsion is obtained. For application by spraying, this emulsion is diluted with water to a solids content of 60%.

### Comparative: Emulsion B Obtained According to Example 7 of Application WO 03/087227.

The emulsion described in example 7 of application WO 03/087227 was reproduced as comparative. The composition of the emulsion B is described in the following table 2.

TABLE 2
Comparative emulsion B

| | | % by |
|---|---|---|
| | | weight |
| | | in the |
| Nature of the constituent | Identification | emulsion |
| Phenylated siloxane oil | Constituent (a) | 31.94 |
| M-(D^{Ph/Me})₂₀-(D)₈₀-M with a dynamic | | |
| viscosity equal to 10⁻¹ Pa · s at | | |
| 25° C. ⁽¹⁾ | | |
| Hydroxylated linear | Constituent (a′) | 7.98 |
| polydimethylsiloxane comprising | Ratio by weight | |
| (CH₃)₂(OH)SiO_{1/2} endings with a | (a)/(a′) = 0.25 | |
| dynamic viscosity equal to | | |
| 0.75 Pa · s at 25° C. | | |
| MDT-OH resin | Constituent (b) | 5.71 |
| Methyltriethoxysilane | Constituent (c) | 0.38 |
| Dioctyltin dilaurate emulsion | Constituent (d) | 0.24 |
| Polyethoxylated isotridecyl | Constituent (e) | 2.71 |
| alcohol | | |
| NH₂—(CH₂)₃—Si(OH)₃⁽⁵⁾ | Constituent (g) | 2.42 |
| Antifoaming agent | | 0.20 |
| Antioxidant | | 0.05 |
| Bactericide | | 0.02 |
| Thickening agent (xanthan gum) | | 0.11 |
| Wetting agents | | 0.30 |
| Distilled water | Constituent (f) | 47.94 |
| | | 100 |

TABLE 3
Emulsion C = comparative

| | | Parts |
|---|---|---|
| | | by |
| Nature of the constituent | Identification | weight |
| α,ω-Dihydroxylated | Constituent A3 | 32.75 |
| poly(dimethyl)siloxane silicone | | |
| oil, viscosity = 750 mPa · s | | |
| Silicone resin comprising MDT | Constituent D | 1.80 |
| units and comprising 0.5% by | | |
| weight of OH groups (dynamic | | |
| viscosity at 25° C. = 1 Pa · s) | | |
| CaCO₃ (72% CaCO₃ slurry) | Constituent FI | 45.84 |
| Catalyst: dioctyltin dilaurate | Constituent C | 0.11 |
| emulsion | | |
| Surfactant: Rhodasurf ROX - 85% | Constituent SU | 1.54 |
| ethoxylated fatty alcohol | | |
| solution (supplied by Rhodia) | | |
| 23% NH₂—(CH₂)₃—Si(OH)₃ solution | Constituent B′ | 0.98 |
| Plasticizer: Coatex-P50 | Constituent G | 0.80 |
| (supplied by Coatex, based on | | |
| sodium polyacrylate) | | |
| Light-gray pigment | | 0.53 |
| Distilled water | Constituent (iii) | 15.65 |
| | | 100 |

### Preparation of Emulsion C (Comparative)

The breakdown of the emulsion is described in table 3.
A mixture of the constituent A3, of the hydroxylated silicone resin D and of the plasticizer G is prepared in a beaker (and using an anchor stirrer);
the water, the surfactant SU and the filler FI are introduced into a 1.5 liter IKA reactor and then stirring is carried out at 100 revolutions/min for 10 minutes;
the above silicone phase (i) is gradually introduced using a dropping funnel and with stirring (150 revolutions/min) into the IKA reactor comprising the surfactant SU, the filler FI and the water;
subsequently, the adhesion promoter B′ and the catalyst C are added and stirring is carried out for a further 10 min. An oil-in-water emulsion is obtained. For application by spraying, this emulsion is diluted with water to a solids content of 60%.

### EXAMPLE 2

a) Emulsions A (inventive), B (comparative) and C (comparative) are applied, by spraying using a compressed air gun, to a sheet of rubber originating from a bladder (rubber of butyl type). After drying at ambient temperature for one hour, the sheet is placed in an oven at 170° C. for 10 minutes in order to make possible the complete evaporation of the water and to accelerate the crosslinking. The amount of product applied is determined by difference in weight (layer of 5 mg/cm² approximately).

b) Each sheet of bladder coated with the test primer is subsequently subjected to an extension of 300%.

c) The layer of primer is subsequently examined using a binocular magnifier (×20) in order to evaluate the presence of cracks in the primer during the extension and/or after the extension.

The primer resulting from emulsion A (invention) does not exhibit any cracks.

The primer resulting from emulsion B (comparative) exhibits cracks and does not register an elongation at 300%.

The primer resulting from emulsion C (comparative) does not exhibit any cracks.

### EXAMPLE 3

### Durability Test

### a) Invention

A bladder coated with a primer resulting from emulsion A (invention) obtained according to the protocol described in example 2 (stages (a) and (b)) is treated by spraying with a standard lubricating composition (lubricating silicone composition XR3900RTU supplied by Rhodia).

The operation is repeated with a bladder coated with a primer resulting from emulsion C (comparative).

The durability of the (bladder/primer) system corresponds to the number of tires produced without deterioration in the surface of the inflatable bladder. The test bladder is pressed in contact with a non-vulcanized tire cover film according to a series of pressure and temperature cycles which simulates the stages of manufacture of a tire on the industrial equipment (typically curing at 170° C. for 7 minutes for each molding/mold release cycle for a private car tire).

The tire cover film is replaced at each molded. The test is complete when the two surfaces in contact remain stuck together.

The bladder coated with the primer resulting from emulsion A (invention) makes possible more than 40 molding/mold release cycles without sticking of the tire. It is also noted that the adhesion of the primer to the bladder is good even after more than 40 molding/mold release cycles.

### b) Comparative

A bladder coated with the primer resulting from emulsion C (comparative) obtained according to example 2 is treated by spraying with a standard lubricating composition (lubricating silicone composition XR3900RTU supplied by Rhodia). The bladder coated with the primer resulting from emulsion C exhibits problems of detachment between the primer and the bladder. The adhesion between the primer and the bladder is insufficient to provide molding/mold release cycles.

It should be clearly understood that the invention defined by the appended claims is not limited to the specific embodiments indicated in the above description but encompasses the alternative forms thereof which depart neither from the scope nor from the spirit of the present invention.

What is claimed is:

1. An aqueous silicone emulsion
said emulsion being composed:
(i) of a silicone phase composed:
of at least one crosslinkable linear polyorganosiloxane oil A comprising at least one hydroxyl or alkoxyl functional group and having a dynamic viscosity of between 20 000 and 2×10⁶ mPa·s,
of at least one crosslinking agent D comprising at least one hydroxylated or alkoxylated polyorganosiloxane, or a silicon-comprising adhesion promoter having at least one hydroxyl or alkoxyl crosslinking functional group,
when the crosslinking agent D is not a silicon-comprising adhesion promoter having hydroxyl and/or alkoxyl crosslinking functional groups, at least one silicon-comprising adhesion promoter B is optionally present,
wherein at least one of the constituents A, B and D carries at least three crosslinking functional groups per molecule, and
(ii) of a non-silicone hydrophilic phase composed:
of at least one filler FI dispersible in an aqueous phase in a proportion of at least 5% by weight, with respect to the total weight of the emulsion;
of at least one surfactant SU, and
optionally of at least one polycondensation catalyst C or at least one adhesion promoter B′ which is soluble in water or both, and
(iii) of water,
said emulsion optionally comprising, as additional additives, at least one plasticizer G or at least one bactericide H or both.

2. The emulsion of claim 1, wherein the filler FI dispersible in the aqueous phase is selected from the group consisting of colloidal silicas, fumed silica powders, precipitated silica powders, a calcium carbonate, micas and mixtures thereof.

3. The emulsion of claim 1 wherein said emulsion further comprises water such that the water is present between 0.5% and 55% by weight, with respect to the total weight of the emulsion.

4. The emulsion of claim 1 wherein the surfactant SU is present at up to 3% by weight, with respect to the total weight of the emulsion.

5. The emulsion of claim 1, wherein
the polyorganosiloxane A is a polydiorganosiloxane oil exhibiting, per molecule, at least two condensable or hydrolysable groups SiOR^{a}, with:
R^{a}═H or alkyl, preferably R^{a}═H;
said polyorganosiloxane A capable of being crosslinked by condensation or hydrolysis/condensation, optionally in the presence of a condensation catalyst C; and
the crosslinking agent D comprises at least one hydroxylated and/or alkoxylated silicone resin and optionally at least one alkoxysilane E.

6. The emulsion of claim 1 wherein the polyorganosiloxane A has the following formula (I):
[(R^{f}O)ₐR^{e}₍₃₋ₐ₎SiO_{1/2}][R³R⁴SiO_{2/2}]ₘ[R⁵R⁶SiO_{2/2}]ₙ[R⁷R⁸SiO_{2/2]}ₒ[R³R^{N}SiO_{2/2}]ₚ[(R^{f}O)ₐR^{e}₍₃₋ₐ₎SiO_{1/2}]
in which formula:
R^{f}=corresponds to hydrogen or to a linear or branched C₁-C₄ alkyl, optionally substituted by a linear or branched C₁-C₃ alkyl
—R³, R⁴, R⁵, R⁶, R⁷ and R⁸ are identical or different radicals chosen from the group consisting of: linear or branched C₁-C₃₀ alkyls, C₆-C₁₂ aryls, optionally substituted by 1 to 3 linear or branched C₁-C₃ alkyls, aralkyls comprising, for the aryl part, C₆-C₈ carbon atoms and, for the linear or branched alkyl part, C₁-C₄ carbon atoms, and aralkenyls comprising, for the aryl part, C₆-C₈ carbon atoms and, for the linear or branched alkenyl part, C₁-C₄ carbon atoms,
R^{N} corresponds to radicals, identical to or different from one another, which are defined as being aminated radicals, or alkyl radicals comprising one or more epoxide, carboxyl, methacryloyloxy, mercapto, isocyanate, isocyanurate or cyano functional groups;
R^{e} represents radicals, identical to or different from one another, which are defined as being radicals corresponding to the same definition as that given above for R³, R⁴, R⁵ and R⁶ or radicals corresponding to the same definition as that given above for R^{N};
a=1, 2 or 3, and
m, n, o and p≧0 with m+n+o+p≧500.

7. The emulsion of claim 6, wherein the polyorganosiloxane A is a silicone oil in which:
R^{f} corresponds to hydrogen,
a=1, and
R^{e} and R³ to R⁸ are radicals, identical to or different from one another, selected from the group consisting of:
linear or branched C₁-C₁₅ alkyls,

8. The emulsion of claim 1 wherein said emulsion is characterized by the following composition, in parts by weight:
100 parts of at least one α,Ω-dihydroxylated polydiorganosiloxane silicone oil A,
from 0 to 10 parts:
of at least one adhesion promoter B and/or B′ selected from the group consisting of: an hydrolysis product of an aminoalkyltrialkoxysilane, aminated silicone oligomers or resins comprising at least one D, T or Q siloxyl unit or a combination thereof, optionally an M siloxyl unit, with at least a portion of the at least one D, T and M units carrying one or more amine functional groups,
from 1 to 20 parts of at least one crosslinking agent D comprising:
at least one hydroxylated silicone resin, having at least one silicon substituted by vinyl, phenyl, 3,3,3-trifluoropropyl or linear or branched C₁-C₆ alkyl radicals,
from 0 to 5 parts of at least one alkoxysilane E of formula:
R^{b}₍₃₋ₜ₎Si(OR^{a})ₜ
with R^{a}═H or alkyl, R^{b}=optionally substituted C₁-C₆ (cyclo)alkyl or alkenyl, and t=1, 2 or 3;
from 0 to 2 parts of at least one polycondensation catalyst C;
from 0.5 to 10 parts of at least one surfactant SU,
from 2 to 40 parts of at least one siliceous filler FI preferably selected from the group consisting of: a precipitated or non-precipitated silica, a colloidal silica, a silica in powder form, micas and mixtures of these products thereof,
from 0.5 to 50 parts of water, and
from 0 to 20 parts of at least one siliceous additive SA.

9. The emulsion of claim 1 wherein said emulsion comprises droplets of dispersed silicone phase existing in a partially crosslinked form.

10. A dilatable rubber bladder coated on its external surface with an aqueous silicone emulsion as claimed in claim 1.

11. A dilatable rubber bladder coated with the emulsion as claimed in claim 1 and heated at a temperature of 20 to 180° C. to form a bonding primer.

12. The dilatable rubber bladder as claimed in claim 11, further comprising a lubricating composition.

13. (canceled)
